(19) United States
(12) Patent Application Publication
(10) Pub. No.: US 2026/0091749 A1
(43) Pub. Date: Apr. 2, 2026

(54) RESTRAINT DEVICE

(71) Applicants: Carrie Wittick, New Smyrna Beach, FL (US); Leigh Wittick, New Smyrna Beach, FL (US); Benjamin Andrew Harris, New Smyrna Beach, FL (US)

(72) Inventors: Carrie Wittick, New Smyrna Beach, FL (US); Leigh Wittick, New Smyrna Beach, FL (US); Benjamin Andrew Harris, New Smyrna Beach, FL (US)

(21) Appl. No.: 19/324,510

(22) Filed: Sep. 10, 2025

Related U.S. Application Data
(60) Provisional application No. 63/702,207, filed on Oct. 2, 2024.

(51) Int. Cl. B60R 21/12; B60N 99/00

(52) U.S. Cl. CPC B60R 21/12; B60N 99/00

(57) ABSTRACT

A restraint device includes an elongated main body having a top end, a bottom end, a first side edge, a second side edge and a middle section. The main body is constructed from a malleable material with the middle section aligned with the chest of a person on a seat and the side edges being positioned along the back of the seat. A first connector connects the side edges together with the main body encompassing the person and the seat. A pair of dynamic tensioning straps impart a tension force onto the main body to immobilize the person onto the seat. A waist strap extends from the front of the main body, beneath the seat, and engages the back of the main body, and a pair of buckles engage the seatbelt buckles of the seat.

### CROSS-REFERENCE TO RELATED APPLICATIONS

This application claims the benefit of U.S. Application Ser. No. 63/702,207 filed on Oct. 2, 2024, the contents of which are incorporated herein by reference.

### TECHNICAL FIELD

The present invention relates generally to the field of travel safety, and more particularly to a device for temporarily restraining and confining a human to a seat.

### BACKGROUND

The statements in this section merely provide background information related to the present disclosure and may not constitute prior art.

In recent years, there has been an alarming increase in the number of airline passengers exhibiting disorderly, threatening, or dangerous behavior while onboard an aircraft. In many instances, these individuals needed to be temporarily restrained by the flight crew and/or their fellow passengers until the plane could land and law enforcement could take over.

In severe cases, the flight crew and good Samaritan passengers were forced to utilize whatever means they had available to physically restrain the passenger, such as belts, blankets, and tape, for example. As a result, the individual being restrained was typically physically bound and left lying on the floor of the central aisle of the aircraft.

Although this prevented the restrained individual from causing additional trouble, it created a safety problem, as it prevented passengers and flight crew from being able to use the only corridor. As such, if the plane had to make an emergency landing, passengers would not be able to quickly get off of the plane, and because the restrained individual was not in a seat, they could become harmed during the landing.

Accordingly, it would be beneficial to provide a restraint device for temporarily restraining and confining a human to a seat that alleviates the drawbacks described above.

### SUMMARY OF THE INVENTION

The present invention is directed to a restraint device. One embodiment of the present invention can include an elongated main body having a top end, a bottom end, a first side edge, a second side edge and a middle section. In one embodiment, the middle section can include a visible marker for aligning the device with the chest of a person to be restrained onto a seat.

In one embodiment, the main body can include a malleable construction and can be wrapped around the person and the seat to position the first side edge and the second side edge along a back end of the seat, and to be connected together by a first connector such as a zipper.

In one embodiment, a pair of dynamic elastomeric tensioning straps are provided along either side of the zipper. Each of the straps can be stretched in opposite directions and can engage opposing portions of the main body to impart a tension force onto the main body. The tensioning force functioning to reduce the size of the main body and immobilize the person onto the seat.

In one embodiment, a waist strap can extend from the front bottom portion of the main body, beneath the seat, and can engage the back bottom portion of the main body, and a pair of buckles can engage the seatbelt buckles of the seat.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a restraint device that is useful for understanding the inventive concepts disclosed herein.

FIG. 2 is a front perspective view of the restraint device in operation, in accordance with one embodiment of the invention.

FIG. 3 is a back view of the restraint device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors.”

Several nonlimiting examples of connectors include, but are not limited to, flexible strips of interlocking projections with a slider (i.e., zipper), thread-to-connect, twist-to-connect, and push-to-connect type devices, opposing strips of hook and loop material (e.g., Velcro®), attractively-oriented magnetic elements or magnetic and metallic elements, buckles, clamps, sockets, clips, carabiners, and compression fittings, for example.

Each illustrated connector can be permanently secured to the illustrated portion of the device via a permanent sealer such as glue, adhesive tape, or stitching, for example.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

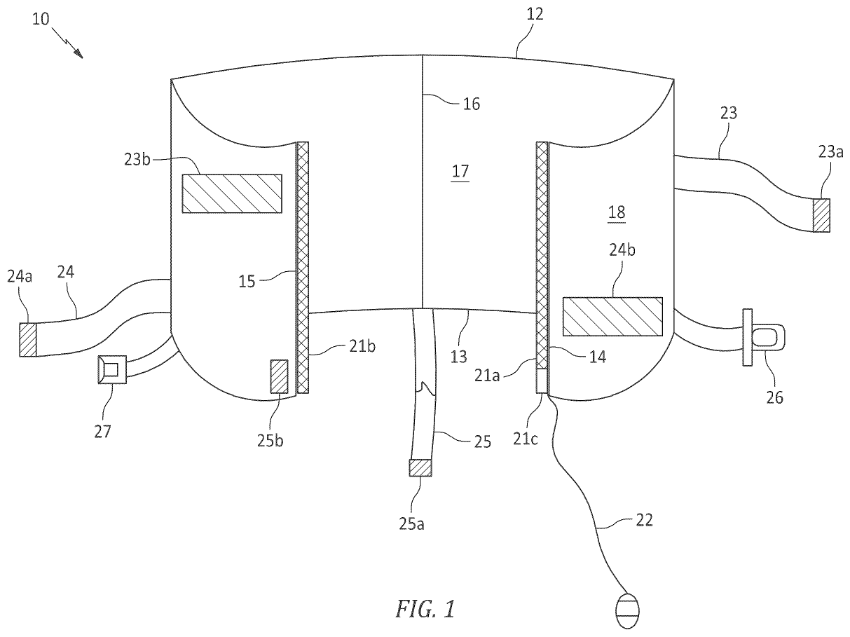

FIGS. 1-3 illustrate one embodiment of a restraint device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown best at FIG. 1. one embodiment of the device 10 can include an elongated main body member 11 having a top end 12, a bottom end 13, a first side edge 14, a second side edge 15, a middle section 16, an inside facing surface 17 and an outside facing surface 18.

As the main body is intended to be wrapped about an individual that is positioned within a seat, such as an airline seat for example, the main body can be manufactured in any number of different shapes and sizes suitable for covering the chest and arms of individuals of different body types and weights in the manner described below.

In the preferred embodiment, the main body 11 can include a layered construction wherein the inside facing surface 17 is constructed from, or is embedded with a malleable padded material such as thick cotton or foam, for example, and wherein the outside facing surface 18 is constructed from a malleable, sturdy and inelastic material such as nylon fabric, or vinyl fabric, for example.

In this regard, the padded inside surface 17 can be in direct contact with an individual being restrained in a seat and can conform to the shape of the individual while in use to absorb some level of movement by the individual. Additionally, the outside facing surface can ideally be provided in a color scheme that matches the color scheme of the aircraft seats, so as to attempt to better blend into the scenery when used. Such a feature is advantageous as this reduces the embarrassment to the restrained individual if/when they recover from the episode that resulted in their restraint and helps to calm other passengers.

In one embodiment, a first connector such as a pair of flexible strips of interlocking projections 21a and 21b having a slider 21c can be connected along the edges 14 and 15 of the main body. The connector functions to selectively secure the edges of the main body together when restraining an individual onto a seat during use of the device.

In the preferred embodiment, an elongated corded handle 22 or other such device can be connected onto the slider 21c to enable the flight crew to quickly disconnect the edges of the main body and release a restrained individual in the event of an emergency situation. Of course, any number of other types of connectors and/or devices capable of quickly disconnecting the device from the seat and/or the individual are also contemplated.

In one embodiment, the device can include a pair of dynamic tensioning straps 23 and 24 each having a first end that is permanently connected to the outside facing surface of the main body along opposite sides of the edges 14 and 15. In the preferred embodiment, one of the straps 23 can be positioned adjacent to the top end 12 of the main body, and the other strap 24 can be positioned adjacent to the bottom end 13 of the main body.

To this end, each of the straps 23 and 24 can include connectors such as hook and loop material 23a and 24a along the respective distal ends. The hook and loop material 23a and 24a from each strap can function to selectively engage an elongated strip of connective hook and loop material 23b and 24b, respectively positioned along the opposite side edge to which the strap extends connected.

Each of the straps 23 and 24 can ideally be constructed from a strong, rip resistant elastomeric material such as elastane or reinforced spandex, for example, that is capable of stretching during operation. In this regard, the dynamic tensioning straps can be used in conjunction with the first connector to tighten and secure the main body laterally about the seat and the restrained individual, so as to immobilize the individual onto the seat. Moreover, by providing elongated strips 23b and 24b, the length and tension of the straps can be adjustable based on the shape and size of the individual being restrained. Of course, any number of other connectors capable of removably securing the straps about the seat and/or body of the individual also contemplated.

In one embodiment, the device can include an elongated seat strap 25 that can extend from the middle 16 and bottom end 13 of the main body. The seat strap can ideally be constructed from an identical material as the tensioning straps 23 and 24 described above, and can also include a connector such as hook and loop material 25a along the distal end for engaging another elongated strip of connective hook and loop material 25b located adjacent to one or both of the edges 14 and 15.

In one embodiment, the device can also include a pair of seatbelt attachment buckles such as a male buckle 26 and a female buckle 27 each having a shape and a size that is suitable for engaging the universal quick release female and male buckles, respectively, found on commercial airline seats.

Although described and illustrated as including these components, it is contemplated that the device may be constructed without elements 25-27 depending on applicable regulations set forth by various airlines and/or airline governing bodies. However, when provided, such components advantageously act secondary mechanisms for further immobilizing and confining a restrained individual to their seat.

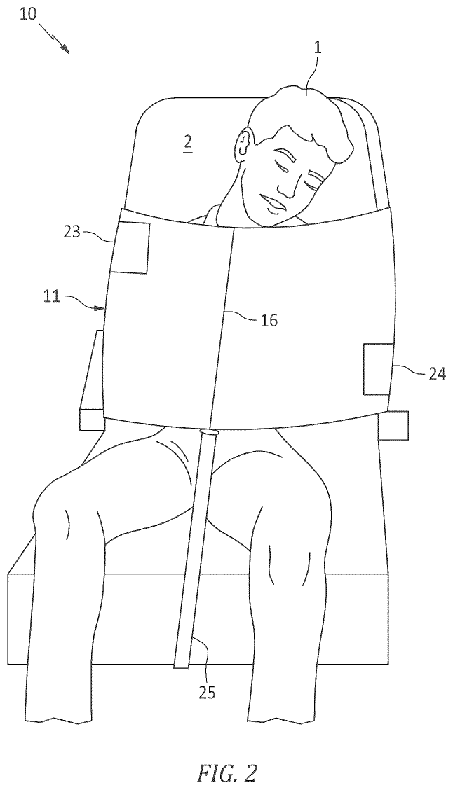

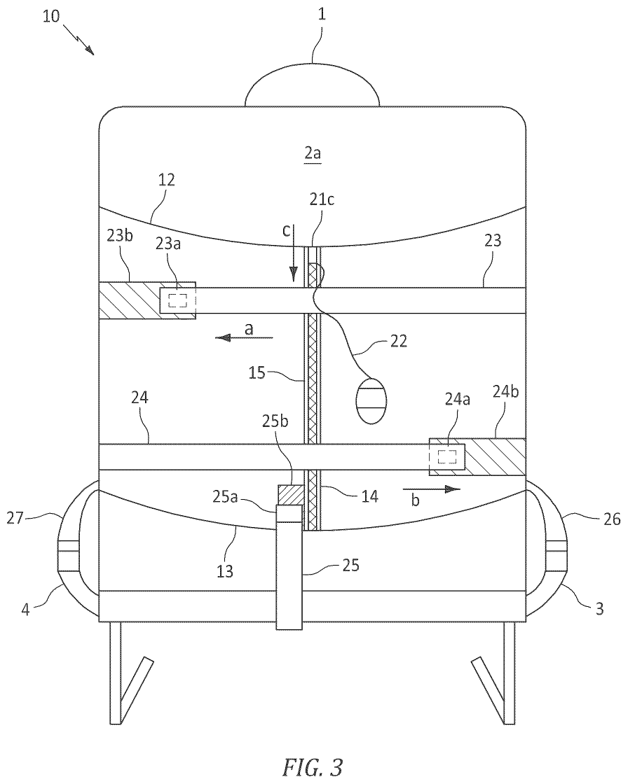

FIGS. 2 and 3 illustrate one embodiment of the device 10 in operation. As shown, an individual 1 can be positioned onto a seat 2, such as an airline seat, for example. When so positioned, the middle section 16 of the main body 11 which can include a visible marking can be aligned with the center of the individuals torso, and the main body can be wrapped around both the individual and the seat until the side edges 14 and 15 are adjacent to each other. In this regard, the main body will encompass both the person and the seat with the side edges being located along the back end 2a of the seat.

Next, the slider 21c of the zipper (or other such connector) can secure the side edges together, and the dynamic tensioning straps 23 and 24 can be stretched to engage the elongated connective strips 24b and 23b, respectively, as shown by arrows a and b to increase the tension and to tighten the main body about the seat and user. When so positioned, the individual will be securely restrained in their seat by the device.

Next, the seat strap 25 can be routed between the legs of the restrained individual and beneath the seat before engaging the connective element 25b, and the seatbelt attachment buckles 26 and 27 can be coupled directly to the quick release buckles 3 and 4 of the airline seat 2.

Importantly, should the aircraft experience an emergency situation, a flight attendant or other individual can immediately free the restrained individual by imparting a swift downward pulling force onto the corded handle 22 as shown by arrow C. Such an action will cause the tensioning straps to become separated and will disconnect the edges of the main body from each other, thus allowing the previously restrained individual to be able to immediately escape the aircraft.

Although described throughout this document with regard to an airline seat, this is for illustrative purposes only, as those of skill in the art will recognize that the inventive device may be utilized to secure an individual into/onto any type of chair or seat found at any location such as a building, train, or vessel, for example. As such, the inventive components are not to be construed as limiting to only the airline industry.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A restraint device comprising:
a main body having a top end, a bottom end, a first side edge, a second side edge, and a middle section;
a first connector that is positioned along the main body;
a first dynamic tensioning strap that is positioned along the main body; and
a second dynamic tensioning strap that is positioned along the main body,
wherein the middle section that is located opposite to the connector and is configured to be aligned with a center portion of a torso of a person sitting on a seat,
wherein the main body is malleable, and is configured to be wrapped around each of the person and the seat to position the first side edge and the second side edge along a back end of the seat, and
wherein the connector is configured to removably secure the first side edge to the second side edge to immobilize the person onto the seat.

2. The device of claim 1, wherein the first connector comprises:
a first strip of interlocking projections that is positioned along the first side edge;
a second strip of interlocking projections that is positioned along the second side edge; and
a slider that positioned along one of the first or second strip of interlocking projections, said slider being configured to removably secure the first strip of interlocking projections to the second strip of interlocking projections.

3. The device of claim 1, wherein the main body includes a layered construction having an inside facing surface and an outside facing surface.

4. The device of claim 3, wherein the inside facing surface of the main body includes a padded material.

5. The device of claim 3, wherein the outside facing surface of the main body is constructed from an inelastic material.

6. The device of claim 5, wherein the outside facing surface is constructed from at least one of nylon fabric or vinyl fabric.

7. The device of claim 1, wherein the first dynamic tensioning strap includes a first end that is positioned along the main body at a location adjacent to the first side edge, and a second end that extends outward therefrom, and
wherein the second dynamic tensioning strap includes a first end that is positioned along the main body at a location adjacent to the second side edge, and a second end that extends outward therefrom.

8. The device of claim 7, wherein the first dynamic tensioning strap and the second dynamic tensioning strap are each constructed from an elastic material.

9. The device of claim 8, wherein the second end of the first dynamic tensioning strap is configured to be selectively positioned at a location adjacent to the second edge of the main body via a stretching force; and
wherein the second end of the second dynamic tensioning strap is configured to be selectively positioned at a location adjacent to the first edge of the main body via another stretching force.

10. The device of claim 9, wherein the stretching force and the another stretching force imparts tension onto the main body and the seat to prevent movement of the person.
